(19) United States
(12) Patent Application Publication
(10) Pub. No.: US 2005/0143103 A1
(43) Pub. Date: Jun. 30, 2005

(54) System, method, device, and computer program product for a sender to send a personalized notification to a recipient of a communication

(75) Inventors: Stephen Dana Bjorgan, San Francisco, CA (US); Romain David, San Francisco, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, S.A, Paris (FR)

(21) Appl. No.: 10/748,143

(22) Filed: Dec. 31, 2003

(51) Int. Cl. H04Q 7/20

(52) U.S. Cl. 455/466; 455/414.2; 455/567

(57) ABSTRACT

In a communication network, a caller selects a personalized notification to be sent together with his call. The personalized notification, for example a personalized ringtone, is sent as a message together with the call. The switching center sends the message to the recipient of the call when the call is routed. The recipient's device determines that the incoming caller matches the sender of the message, and the message is opened, causing the caller's personalized notification to be played on the recipient's device.

### BACKGROUND OF THE INVENTION

The development of the wireless communications market has been staggering. With new technologies and increasing capabilities of wireless devices, new and unforeseen markets have developed that have been hugely lucrative. As a prime example, the market for downloadable ringtones for use with wireless devices such as cellular telephones has developed into a $2-$2.5 billion market over the last several years. It is clear that these new markets will continue to be created and expand as technology matures and wireless devices become even more mainstream.

As technology has evolved, the focus has been on “pull” technologies, where a user can download data or ringtones, for example. Similarly, e-mail, Internet browsing, and text messaging have all been “pull” technologies where the recipient is in control of what is being accessed.

### SUMMARY OF THE INVENTION

The inventors of the present invention have recognized that by providing new “push” technologies for modem wireless networks, new markets can be developed that heretofore have been untapped by the wireless communications industry. As one example, the present inventors have invented a novel system, method, wireless device, and computer program product for a sender to send a personalized notification such as a ringtone, color, picture, video, multimedia message, vibration, text, audible cues, temperature, or other sensory indicator, to a receiving wireless device upon initiation of communication. The present inventors have further recognized that these features are also applicable to fixed line devices.

In one embodiment, in the context of a wireless communication network, a caller selects a personalized ringtone to be sent together with his call. The identification of the personalized ringtone is sent as a short message service (SMS) message at the same time as the call. The mobile switching center sends the SMS message including the identification of the personalized ringtone to the recipient of the call when the call is routed. The recipient's wireless device determines that the incoming caller matches the sender of the SMS message just sent, and the SMS message is opened, causing the caller's personalized ringtone to be played on the recipient's wireless device. In other embodiments of the present invention, the ringtone itself is sent as part of the message. The present invention is not limited to any particular communication technology, such as SMS.

Consistent with the title of this section, the above summary is not intended to be an exhaustive discussion of all the features or embodiments of the present invention. A more complete, although not necessarily exhaustive, description of the features and embodiments of the invention is found in the section entitled “DESCRIPTION OF THE PREFERRED EMBODIMENTS.”

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of an example wireless communication network according to one embodiment of the present invention;

FIG. 2 is a block diagram of an example implementation of a short message service system according to one embodiment of the present invention;

FIG. 3 is a block diagram of an example wireless device according to one embodiment of the present invention;

FIG. 4 is a high-level block diagram of a system for carrying out the present invention according to one embodiment;

FIG. 5 is a flowchart of a process for sending a sender-personalized ringtone according to one embodiment of the present invention;

FIG. 6 is a flowchart of saving a sender-personalized ringtone in a phonebook of a recipient wireless device according to one embodiment of the present invention; and

FIG. 7 is an exemplary computer system programmed to perform one or more of the special purpose functions of the present invention.

### DESCRIPTION OF THE PREFERRED EMBODIMENTS

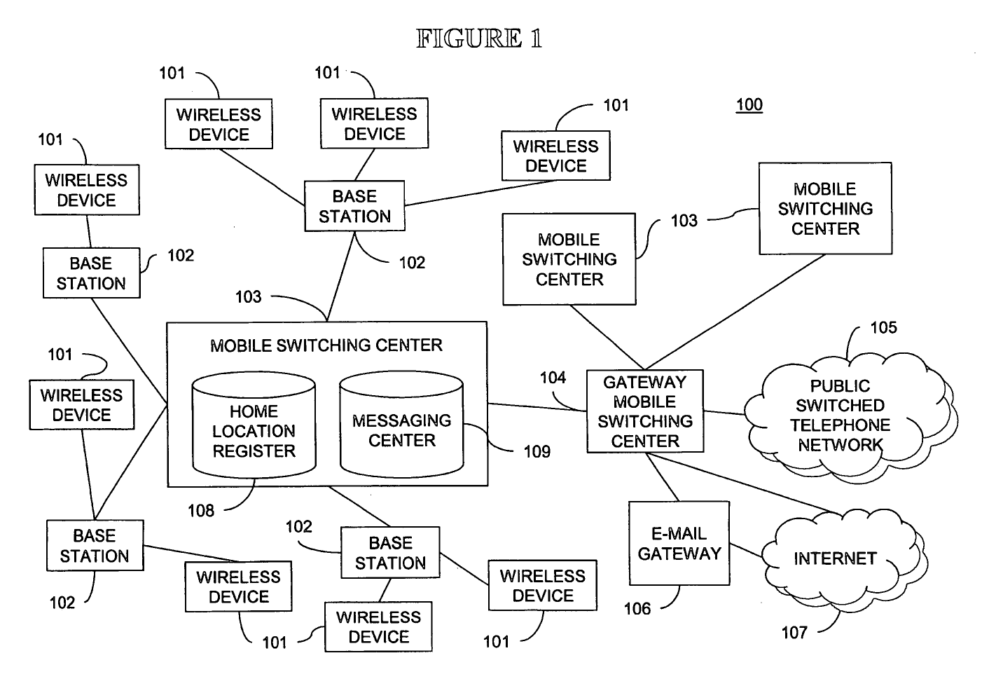

Reference is now made to the drawings, wherein like reference numerals designate identical or corresponding parts throughout the several views, and more particularly to FIG. 1 thereof, which is a block diagram of an example wireless communications network according to one embodiment of the present invention. As one of ordinary skill in the art would recognize, however, the invention is not limited to any particular network configuration, wireless or otherwise.

Wireless communications networks are described in more detail in Gralla, P., “How Wireless Works,” Que, 2002, and in particular in Chapters 10 and 11 thereof, and in Le Bodic, G., “Mobile Messaging Technologies and Services: SMS, EMS and MMS,” John Wiley & Sons, Ltd. 2003, and in particular in Chapter 1 thereof, the entire contents of all three of these chapters being incorporated herein by reference.

FIG. 1 is a high-level block diagram of an example of a basic wireless communications network 100. The wireless communication network 100 could be any of numerous types of networks, including, for example, a cellular communication network, a personal communications service (PCS) network, a third generation (3G) network such as a network compliant with the Third Generation Partnership Project (3GPP), a network based on one or more of time division multiple access (TDMA), code division multiple access (CDMA), Global System for Mobile Communications (GSM) technologies, or any other wireless communication network. The example of FIG. 1 is provided for illustrative purposes to provide a context for explaining the invention. The particular configuration of the example wireless communication network 100 in FIG. 1 does not in any way limit the applicability of the present invention to any particular network configuration, wireless or otherwise. For example, the invention described herein may be practiced using fixed line devices connected to a network such as a conventional public switched telephone network.

As shown in FIG. 1, the wireless communication network 100 includes a plurality of wireless devices 101, a plurality of base stations 102, a plurality of mobile switching centers 103, a gateway mobile switching center 104, a public switched telephone network 105, an electronic mail gateway 106, and another network, in this example, the Internet 107.

The wireless device 101 may be any wireless communication device such as a telephone, personal data assistant (PDA), pager, multi-function device, or other communication device. The wireless device 101 is connected to the wireless communication network 100 through a base station 102. The example wireless communication network 100 includes a single gateway mobile switching center 104. The gateway mobile switching center 104 communicates with a plurality of mobile switching centers 103, which in turn each communicate with a plurality of base stations 102. As a wireless device 101 moves from area to area within the geographic coverage area of the wireless communication network 100, it is passed from one base station 102 to another in order to maintain quality communications.

The mobile switching center 103 routes communications handled by the base stations 102 that it communicates with to the gateway mobile switching center 104. The gateway mobile switching center 104 routes all communications within the wireless communication network 100 to their final destination. The final destination of the communication may be, for example, another wireless device 101 within the wireless communication network 100, a destination on a public switched telephone network (PSTN) 105, a destination on another network, for example the Internet 107, or a wireless device 101 on a different wireless communication network 100. Communications that are routed to the Internet 107 may be routed by the gateway mobile switching center 104 through an electronic mail gateway 106. Communications that are routed to other wireless communications networks 100 are facilitated through “roaming” agreements between the two wireless communication networks 100.

For purposes of this description, the gateway mobile switching center 104 will be considered as simply another mobile switching center 103. This simplification does not have an impact the description of the present invention.

As discussed above, the mobile switching center 103 is responsible for routing communications through the wireless communication network 100. In fact, the mobile switching centers 103 are responsible for the operation of the wireless communication network 100 in general. The mobile switching centers 103 make use of databases to maintain information about users of the wireless communication network 100. Two examples of these databases include a home location register 108 and a messaging center database 109.

The home location register 108 is used to track the location of all wireless devices 101 within range of the particular mobile switching center 103. Each wireless device 101 has a unique identifying number assigned to it that can be used by the mobile switching center 103 to track that wireless device 101. In a GSM network, identification information pertaining to a particular subscriber is included in a subscriber identity module (SIM) card that in some cases can be removed from one wireless device 101 and placed into another. In such an example, the SIM card contains the information that is used to track the wireless device 101 through the home location register 108 of the mobile switching center 103. In other networks, the identification number is stored within the wireless device 101 and is transmitted by the wireless device 101 to the mobile switching center 103.

The messaging center database 109 is used by the mobile switching center 103 to route messages through the wireless communication network 100. These messages may be short message service (SMS) messages, enhanced messaging service (EMS) messages, multimedia messaging service (MMS) messages, or other types of messages sent to and/or from wireless devices 101 within the wireless communication network 100, including, but not limited to immediate messaging (IM) and presence services (IMPS), mobile e-mail, and Internet protocol (IP)-based multimedia service (IMS). SMS, EMS, MMS, IMPS, mobile e-mail, and IMS are described in further detail in chapters 2-7 of Le Bodic, G., “Mobile Messaging Technologies and Services: SMS, EMS and MMS,” John Wiley & Sons, Ltd. 2003, the entire contents of each of these chapters being incorporated herein by reference.

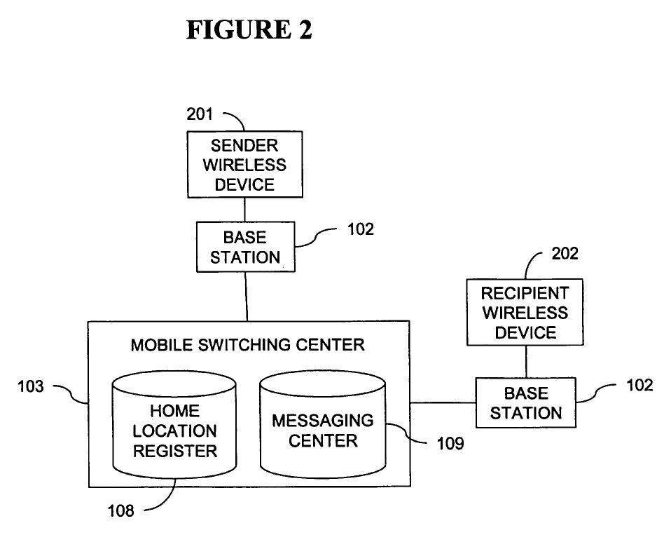

FIG. 2 is a block diagram of a system such as the wireless communication network 100 of FIG. 1 for implementing a short message service (SMS) according to one embodiment of the present invention. As shown in FIG. 2, when a message is sent by a sending wireless device 201, the receiving mobile switching center 103 stores the message in the messaging center 109. The mobile switching center 103 notifies the intended recipient wireless device 202 that a message has been sent to it. When the recipient wireless device 202 has received the message, an acknowledgement of receipt is sent back to the mobile switching center 103, which then causes the message to be removed from the messaging center 109. The mobile switching center 103 will continue to store and repeatedly attempt to send the message to the recipient wireless device 202 until receipt is ultimately acknowledged. As discussed above, SMS is only one example of a communication/signaling/messaging technology that may be used in implementing the present invention. As those of ordinary skill in the art would recognize, the present invention may be implemented using any communication/signaling/messaging technology or combination of technologies that the system and devices were designed to accommodate.

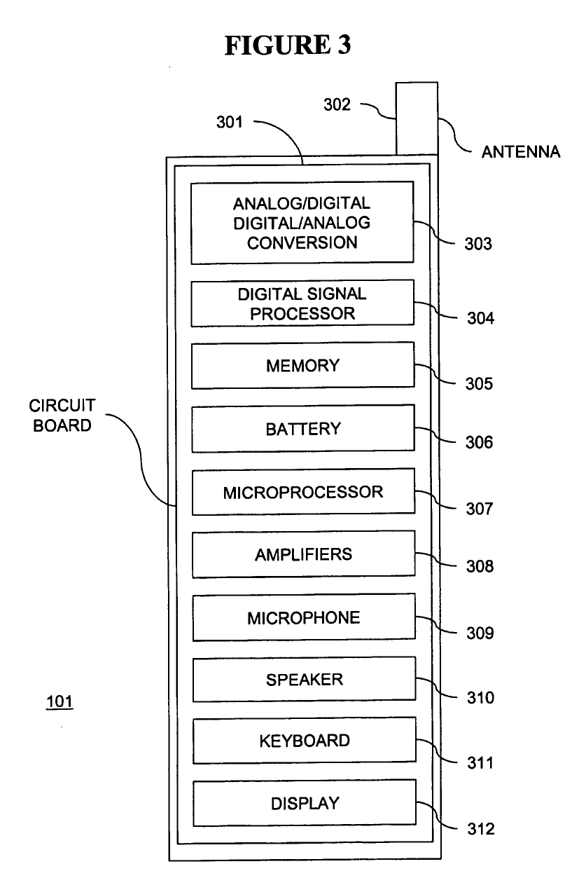

FIG. 3 is a block diagram of a typical wireless device 101 according to one embodiment of the present invention. Throughout this specification and claims, a wireless device is to be understood to be a device that communicates without wires, and may include, but does not necessarily include all of one or more of the components described in the context of FIG. 3. As shown in FIG. 3, the various components of the wireless device 101 are interconnected through a circuit board 301. The example wireless device 101 in FIG. 3 is illustrated in the form of a cellular telephone. However, as described above, the present invention is not limited to any particular type or types of wireless device, but rather could be used in the context of a variety of devices, including a cellular telephone, a personal data assistant (PDA), a pager, a multi-functional device, or other wireless device.

As shown in FIG. 3, the wireless device 101 includes an antenna 302, analog-to-digital (A/D) and digital-to-analog (D/A) conversion circuits 303, a digital signal processor 304, a memory 305, a battery 306, a microprocessor 307, amplifiers 308, a microphone 309, a speaker 310, a keyboard 311, and a display 312. As would be recognized by those of ordinary skill in the art, not all of these components are included in all wireless devices 101 useable with the present invention.

The operation of the wireless device 101 is controlled by the microprocessor 307. The antenna 302 receives and sends the signals to and from the wireless device 101. The A/D and D/A conversion circuits 303 perform, for example, the functions of translating sounds (e.g., a user's voice from the microphone 309) into digital signals that can be processed, and translating digital signals into analog signals (e.g., a sound to be sent to the speaker 310). As would be understood by those of ordinary skill in the art, the digital signal processor 304, performs processing on the signals that are both received and transmitted by the wireless device 101, and the amplifiers 308 are used to amplify the signals both received and transmitted by the wireless device 101. As would be further understood by those of ordinary skill in the art, the microphone 309 is used to detect a sound and convert it into an analog signal that can be processed, the speaker 310 is used to make the information contained in selected signals audible, the keyboard 311 is used to receive input from a user, the display 312 is used to provide visual feedback to a user, and the battery 306 is used to provide electricity to the various components of the wireless device 101.

The microprocessor 307 is programmed with instructions that are stored in the memory 305. In FIG. 3, the memory 305 is shown as a single element, but as those of ordinary skill in the art would understand, the memory may include several types of memory based on the particular design of the wireless device 101. The memory 306 may include, for example, one or more types of memory (e.g., random access memory (RAM), read only memory (ROM), programmable ROM (PROM), erasable PROM (EPROM), electrically erasable PROM (EEPROM), any type of flash memory, removable memory, etc.). As those of ordinary skill in the art would understand, a memory hierarchy can be designed to meet a variety of requirements. A memory hierarchy is designed to store information in the most appropriate memory media based on, for example, the volatility of the information and the access performance characteristics of the particular memory type. Some information may be stored in volatile memory, while other information is stored in non-volatile memory. The present invention does not require, and is not limited to any particular memory type or structure.

The memory 305 also holds data that is accessible by applications operating on the wireless device 101. For example, for a cellular phone wireless device 101, the memory 305 may store a phone book that can be maintained by the user. Other information that may be held in the memory includes, but is not limited to, configuration information of the wireless device 101, games, user-selectable ringtones, calendar information, e-mail information, messages that have been received by the wireless device 101, voice recorded messages, call logs, etc. Software applications that are run by the microprocessor 307 may access this data in the memory. Some of these software applications may be interactive applications, wherein information is presented to the user through, for example, the display 312, the speaker 310, or other mechanism (e.g., a vibrator), and information is collected through, for example, the microphone 309, the keyboard 311, or other mechanism.

Those of ordinary skill in the art would understand that a common application for cellular phone wireless devices 101 is a phonebook database that can store phone numbers in the memory 305. In some devices, a user may assign a particular ringtone to a particular entry in the phonebook, so that the user-selected ringtone is played to alert the user that a particular person (or group of persons assigned to the same user-selected ringtone) is calling. By recognizing the number of the incoming call, a simple comparison is made in the database to determine if an entry exists for the incoming caller, and if so, whether a user-selected ringtone has been assigned to it. If so, the user-selected ringtone is played, rather than the default ringtone. In this way, the user of the wireless device 101 can determine who is calling without looking at the phone.

Other examples of applications for wireless devices 101 include allowing a user to display a particular image based on the incoming phone number, changing the look-and-feel of the information displayed to the user, providing an Internet browsing capability, e-mail capability, etc. Each of these example applications is implemented on the wireless device 101 by the microprocessor 307 and makes use of the memory 305.

The inventors of the present invention have recognized that a user's experience with a communication device, including, but not limited to a wireless device 101, may be further enhanced by providing “push” capabilities to the user. In particular, the present inventors have invented novel systems, methods, devices, and computer program products through which a user can impact the behavior of, for example, the wireless device 101 of another user. In one embodiment of the present invention, a caller sends a caller-specified notification to a recipient device. Examples of the present invention include sending a selected ringtone, color, picture, video, multimedia message, vibration, text, audible cue, temperature, or other sensory indicator to a recipient device. As those of ordinary skill in the art would recognize, a ringtone could include not only a melody, but also could include, for example, a recorded voice message, an advertisement, a joke, a sound or other audible notification. Those of ordinary skill in the art would further recognize that a device's vibration motor can be programmed to be controllable, and that other display technologies such as, for example, temperature control and color control could also be made programmable as those technologies are included in personal communication devices.

As discussed above, the present invention is not limited to wireless devices 101, but rather may also be carried out using non-wireless communication devices, such as a processor-equipped telephone connected to a PSTN 105. The present invention provides enhanced experiences for users of communication devices and will also produce new revenue opportunities.

The present inventors recognized that by taking advantage of both the processing capabilities of the wireless device 101 and the capabilities provided by, for example, SMS, new capabilities could be delivered to the user. In one embodiment of the present invention, a caller chooses a personalized ringtone that will be sent to the wireless device 101 he is calling. When the caller places the call, an SMS message containing the identification of the sender-personalized ringtone is sent at the same time. At call initiation, the receiving wireless device 101 determines if it has received an SMS message at the same time the incoming call was placed. If the receiving wireless device 101 received an SMS message from the same number as the incoming call, the SMS message is opened and the caller's personalized ringtone corresponding to the identification sent in the SMS message is played, rather than the ringtone configured by receiver of the call. This fun new feature will allow a user to send “personalized” calls that will play a ringtone determined by the caller, not the called.

By making use of SMS as a carrier of caller information, the inventors of the present invention have devised a system, method, device, and computer program product for sending much more than just a call. Not only may the identification of a ringtone be sent, but in other embodiments, one or more sensory indicators are sent, including, but not limited to, a sender-personalized image being displayed, a software update being sent, an audio message such as a voice message being sent, a video or multimedia message being displayed, a color or temperature being sent, etc. It was the present inventors that recognized that the processing power and increased memory capacity of wireless devices 101, and other communication devices, including, but not limited to fixed line devices, may be tapped to enhance the user's experience and open new markets that have heretofore been “pull-centric.” Fixed line devices may include, for example, telephones and television set-top boxes. In other words, the present inventors have enabled a capability whereby a caller may share an experience with the person being called.

As those of ordinary skill in the art would recognize, the communication/signaling/messaging technology is not limited to SMS. To the contrary, the present invention may be carried out using any communication technique that was enabled by the system and devices making use of the present invention. Those of ordinary skill in the art would further recognize that variations of the present invention may be carried out based on the capabilities of the underlying communication technology employed. For example, rather then sending an identification of a ringtone, as described in the example above, the communication technology may allow for the ringtone itself to be sent as part of the message containing the sender personalized notification. Those of ordinary skill in the art would recognize that the capabilities of the devices and communication technologies will allow for many variations of implementing a sender personalized notification while staying true to the present invention.

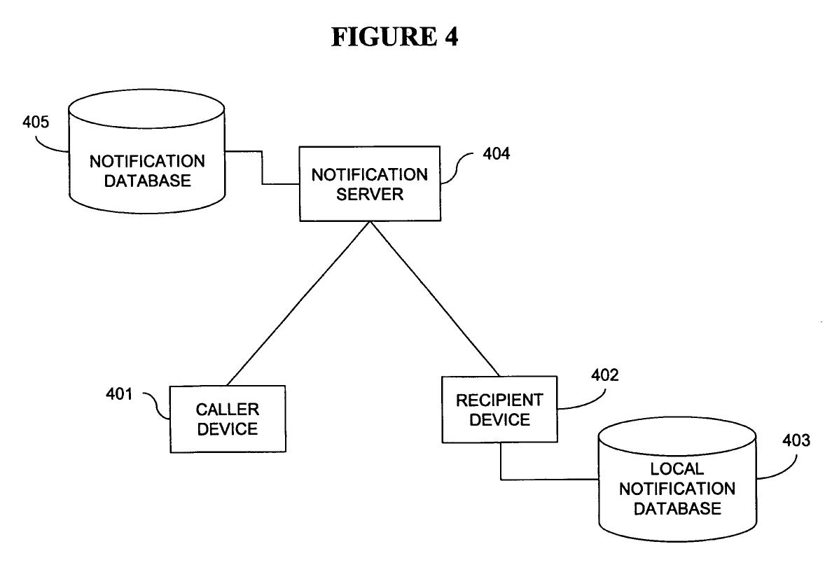

FIG. 4 is a high-level block diagram of a system for carrying out the present invention according to one embodiment. As shown in FIG. 4, the system includes a caller device 401, a recipient device 402, and a personalized notification server 404. The personalized notification server 404 includes a notification database 405 that includes, for example, ringtones that may be sent as a personalized notification where each ringtone is identified in the notification database 405 with a unique identifier. The recipient device 402 includes a local notification database 403 that includes, for example, ringtones that are activated when a particular caller device 401 calls the recipient device 402. In the local notification database 405 an identification of a caller device 401 is associated with a particular ringtone stored on the recipient device 402. In other embodiments of the present invention, rather than associating a caller device 401 to a particular ringtone, a caller is associated to a particular ringtone. In such embodiments, the caller may correspond to a group of caller devices 401.

In one embodiment of the present invention, the caller device 401 specifies a combination of a recipient device 402 to call and a notification (e.g., ringtone) to push to the recipient device. Software running on the recipient device 402 interacts with the caller to collect this information. A data connection is then established between the caller device 401 and the notification server 404. The connection between the caller device 401 and the notification server 404 may be synchronous or asynchronous, and may make use of any appropriate communication/signaling/messaging technology, including, but not limited to TCP/IP, SMS, EMS, MMS, or IMPS, etc. The caller device 401 sends the combination of recipient device 402 to call and notification to push to the notification server 404.

The notification server 404 then creates a message including the combination of recipient device 402 to call and notification to push, and sends it the recipient device 402. The recipient device 402 then sets up the notification to correspond to the caller device 401 in its local notification database 403. Next, the caller device 401 initiates the call to the recipient device 402. Software running on the recipient device will recognize the identity of the caller device 401 and play the pushed notification on the recipient device 403. Depending on the characteristics of the notification (e.g., sound, image, color, temperature, text, etc.) “playing” the notification will, of course, mean implementing the appropriate display of the sensory indicator.

In some embodiments of the present invention, the call itself is never placed. In other words, the caller device 401 may simply push a notification to the recipient device 402 or group of recipient devices.

Those of ordinary skill in the art would recognize that implementations of the present invention may include different variations of managing the storing and transmission of the identification of the notification files and the notification files themselves. For example, in some embodiments of the present invention, a determination is made whether the pushed notification is already stored in the recipient device's 402 local notification database 403 prior to unnecessarily sending the notification again.

A variation within the scope of the present invention includes calling not one recipient device 403, but rather a group of devices, where each of those devices will receive the notification pushed by the caller device 401. This variation of the present invention is useful, for example, for setting up a conference call with a group of recipient devices 402, broadcasting an emergency notification, etc.

Another variation includes managing the reuse of notifications pushed by a caller deivce 401. For example, some notifications may be single use notifications such as pushing a “happy birthday” ringtone to a recipient device 402 on the recipient's birthday, whereas other notifications may be stored in the recipient device's 402 local notification database 403 to be reused each time the caller device 401 calls. Yet another variant of the present invention includes a caller replacing a notification associated him in the recipient device's 402 local notification database 403.

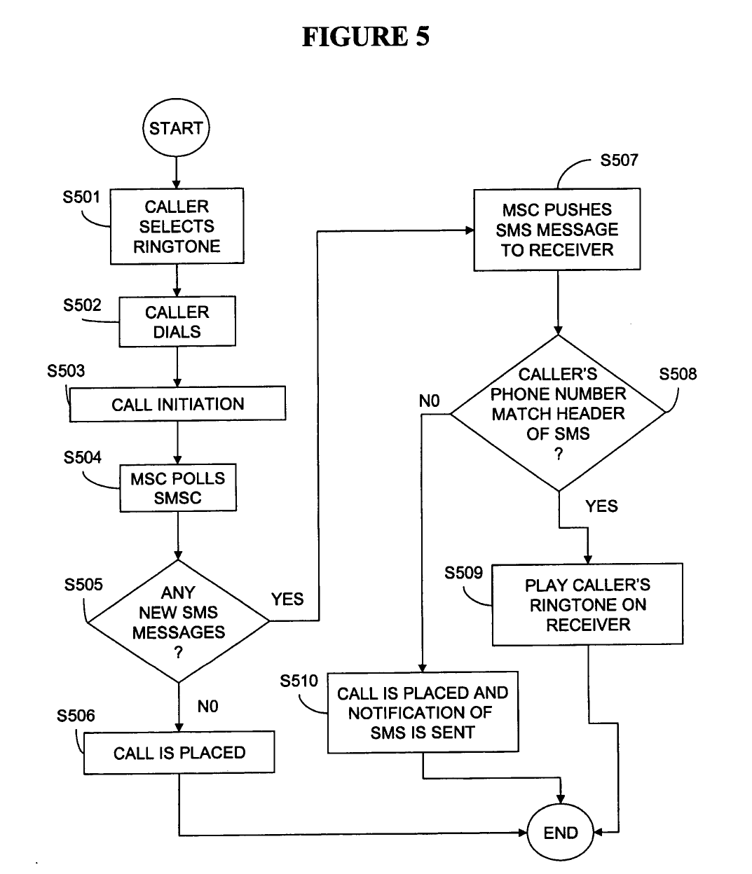

FIG. 5 is a flowchart showing a high-level summary of a process through which the present invention may be implemented, for example, in the context of a wireless device 101 of a wireless communication network 100. As shown in FIG. 5, the process begins at step S501 where a caller selects a sender-personalized ringtone to be sent together with the placed called. The process then proceeds to step S 502 where the caller dials or selects, for example, from a phonebook on the wireless device 101, the phone number of the wireless device 101 he is calling. In one embodiment of the present invention, steps S501 and S502 are accomplished using an application that prompts the caller for information including the ringtone and the phone number to be called. As those of ordinary skill in the art would recognize, steps S501 and S502 could be performed using a variety of techniques, none of which would limit the present invention. In other embodiments of the present invention, rather than selecting a ringtone to be sent with the placed called, the caller may select an image to be displayed, or other information as described above, that could be transmitted to the recipient of the call together with the placed called. Throughout this specification and claims, the phrase “call” means any communication between devices, and is not limited to a person-to-person phone call.

The process then proceeds to step S503 where the call is initiated through the mobile switching center 103. As discussed above, the mobile switching center 103 includes both a home location register 108 and a messaging center 109. In step S503 the call is initiated at about the same time an SMS message including the sender-personalized ringtone is sent. The process then proceeds to step S504 where the mobile switching center 103 polls the messaging center to determine whether a new SMS message has been sent by the caller. The process then proceeds to step S505 where it is determined whether the messaging center 109 has any new SMS messages. If it is determined at step S505 that no new SMS messages have been received from the caller at the messaging center 109 (i.e., “NO” at step S505), the process proceeds to step S506 where the call is sent through to the recipient of the call as would be normally done outside of the context of this invention. After the normal call is sent through at step S506, the process ends.

If, on the other hand, it is determined at step S505 that the messaging center 109 has received a new SMS message from the caller (i.e., “YES” at step S505), the process proceeds to step S507 where the mobile switching center 103 pushes a new SMS message to the designated recipient of the SMS message. The process then proceeds to step S508 which is, in one embodiment, performed by the wireless device 101 of the user being called by the caller. At step S508, the phone number of the caller of the incoming call is compared to the phone number of the sender of the incoming SMS message. If the phone number of the caller of the incoming call matches the phone number of the sender in the header of the SMS message (i.e., “YES” at step S508), the process proceeds to step S510. At step S510, the wireless device 101 of the recipient of the phone call from the caller plays the ringtone included in the SMS message on the recipients wireless device 101, rather than the ringtone that the recipient has configured his wireless device 101 to play. After step S510, the process ends and the call is connected as any other call would be.

If, on the other hand, the phone number of the incoming caller does not match a phone number in the header of the new SMS message (i.e., “NO” at step S508), the process proceeds to step S509 where the call is sent through to the receiver as normal, and a notification of a new SMS message is sent separately. After step S509, the process ends.

As would be understood by those of ordinary skill in the art, the processing required to implement the invention as described in the context of FIG. 5 may be implemented in many different ways while staying true to the invention. For example, the processing performed by the caller's wireless device 101, the mobile switching center, and the recipient's wireless device 101 may be distributed differently based on constraints that may be present in a particular implementation.

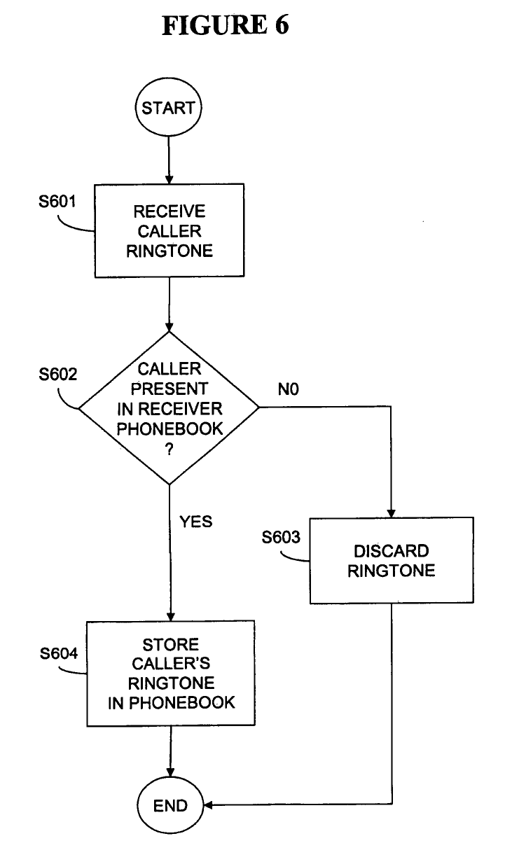

FIG. 6 is a flowchart illustrating an example of a new feature that could be provided to users of wireless devices 101 as a result of the present invention. As shown in FIG. 6, the process begins at step S601 where the recipient of a call receives a personalized ringtone from a caller, for example, through the process described in context of FIG. 5 above. The process then proceeds to step S602 where the wireless device 101 determines whether the caller is currently present in the phonebook maintained on the recipient's wireless device 101. If it is determined that the caller is not present in the recipient's phonebook (i.e., “NO” at step S602), the process proceeds to step S603 where the sender-personalized ringtone is discarded after being played on the recipient's receiver and the call has been connected. After the ringtone has been discarded at step S603, the process ends.

If, on the other hand, it is determined that the caller's phone number is present in the recipient's phonebook (i.e., “YES” at step S602), the process proceeds to step S604 where the sender-personalized rigntone is stored in the recipient's phonebook together with the caller's phonebook entry. After the sender-personalized ringtone has been stored in the recipient's phonebook, the process ends. As a result of this process, the recipient's phone will continue to ring with the sender-personalized ringtone, even if the caller does not send a personalized ringtone on a future call.

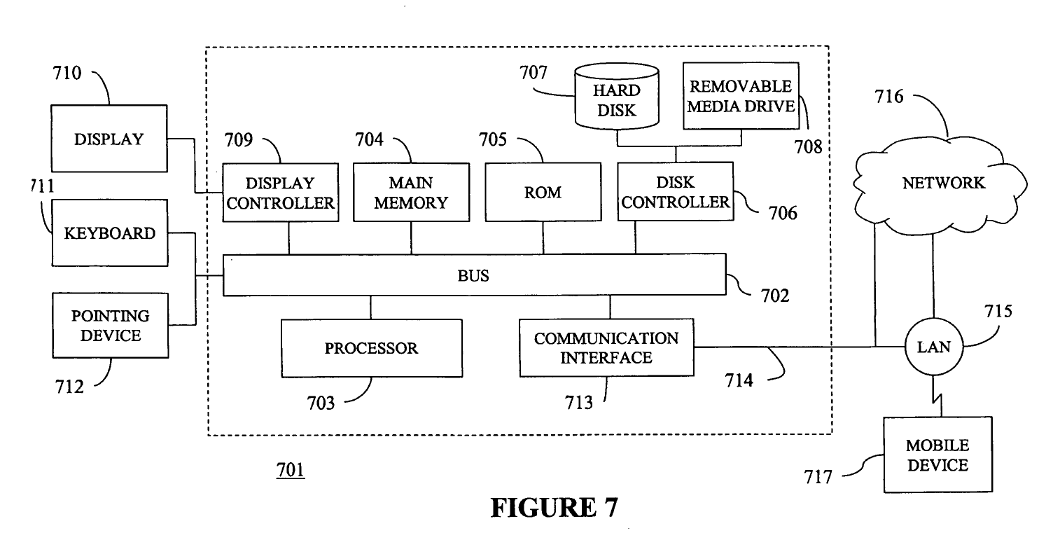

FIG. 7 illustrates a computer system 701 upon which an embodiment of the present invention may be implemented. The computer system 701 includes a bus 702 or other communication mechanism for communicating information, and a processor 703 coupled with the bus 702 for processing the information. The computer system 701 also includes a main memory 704, such as a random access memory (RAM) or other dynamic storage device (e.g., dynamic RAM (DRAM), static RAM (SRAM), and synchronous DRAM (SDRAM)), coupled to the bus 702 for storing information and instructions to be executed by processor 703. In addition, the main memory 704 may be used for storing temporary variables or other intermediate information during the execution of instructions by the processor 703. The computer system 701 further includes a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703.

The computer system 701 also includes a disk controller 706 coupled to the bus 702 to control one or more storage devices for storing information and instructions, such as a magnetic hard disk 707, and a removable media drive 708 (e.g., floppy disk drive, read-only compact disc drive, read/write compact disc drive, compact disc jukebox, tape drive, and removable magneto-optical drive). The storage devices may be added to the computer system 701 using an appropriate device interface (e.g., small computer system interface (SCSI), integrated device electronics (IDE), enhanced-IDE (E-IDE), direct memory access (DMA), or ultra-DMA).

The computer system 701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 701 may also include a display controller 709 coupled to the bus 702 to control a display 710, such as a cathode ray tube (CRT), for displaying information to a computer user. The computer system includes input devices, such as a keyboard 711 and a pointing device 712, for interacting with a computer user and providing information to the processor 703. The pointing device 712, for example, may be a mouse, a trackball, or a pointing stick for communicating direction information and command selections to the processor 703 and for controlling cursor movement on the display 710. In addition, a printer may provide printed listings of data stored and/or generated by the computer system 701.

The computer system 701 performs a portion or all of the processing steps of the invention in response to the processor 703 executing one or more sequences of one or more instructions contained in a memory, such as the main memory 704. Such instructions may be read into the main memory 704 from another computer readable medium, such as a hard disk 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 701 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 701, for driving a device or devices for implementing the invention, and for enabling the computer system 701 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 703 for execution. A computer readable medium may take many forms, including but not limited to, non-volatile media, volatile media, and transmission media. Non-volatile media includes, for example, optical, magnetic disks, and magneto-optical disks, such as the hard disk 707 or the removable media drive 708. Volatile media includes dynamic memory, such as the main memory 704. Transmission media includes coaxial cables, copper wire and fiber optics, including the wires that make up the bus 702. Transmission media also may also take the form of acoustic or light waves, such as those generated during radio wave and infrared data communications.

Various forms of computer readable media may be involved in carrying out one or more sequences of one or more instructions to processor 703 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 701 may receive the data on the telephone line and use an infrared transmitter to convert the data to an infrared signal. An infrared detector coupled to the bus 702 can receive the data carried in the infrared signal and place the data on the bus 702. The bus 702 carries the data to the main memory 704, from which the processor 703 retrieves and executes the instructions. The instructions received by the main memory 704 may optionally be stored on storage device 707 or 708 either before or after execution by processor 703.

As would be understood by those of ordinary skill in the art, communications between devices or components may also be performed using wireless technologies including, but not limited to Bluetooth, IEEE 802.11, IEEE 802.11b, ultrawideband, or other technologies.

The computer system 701 also includes a communication interface 713 coupled to the bus 702. The communication interface 713 provides a two-way data communication coupling to a network link 714 that is connected to, for example, a local area network (LAN) 715, or to another communications network 716 such as the Internet. For example, the communication interface 713 may be a network interface card to attach to any packet switched LAN. As another example, the communication interface 713 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local network 715 (e.g., a LAN) or through equipment operated by a service provider, which provides communication services through a communications network 716. In preferred embodiments, the local network 714 and the communications network 716 preferably use electrical, electromagnetic, or optical signals that carry digital data streams. The signals through the various networks and the signals on the network link 714 and through the communication interface 713, which carry the digital data to and from the computer system 701, are exemplary forms of carrier waves transporting the information. The computer system 701 can transmit and receive data, including program code, through the network(s) 715 and 716, the network link 714 and the communication interface 713. Moreover, the network link 714 may provide a connection through a LAN 715 to a mobile device 717 such as a personal digital assistant (PDA) laptop computer, or cellular telephone. The LAN communications network 715 and the communications network 716 both use electrical, electromagnetic or optical signals that carry digital data streams. The signals through the various networks and the signals on the network link 714 and through the communication interface 713, which carry the digital data to and from the system 701, are exemplary forms of carrier waves transporting the information. The processor system 701 can transmit notifications and receive data, including program code, through the network(s), the network link 714 and the communication interface 713.

Obviously, numerous modifications and variations of the present invention are possible in light of the above teachings. It is therefore to be understood that within the scope of the appended claims, the invention may be practiced otherwise than as specifically described herein.

1. A system for pushing a sender-personalized notification, comprising:
a sender device; and
a recipient device, wherein the sender device is configured to select the sender-personalized notification and a destination for the sender-personalized notification corresponding to the recipient device and to send the sender-personalized notification to the recipient device, and
the recipient device is configured to receive the sender-personalized notification and to process the sender-personalized notification based on a type of the sender-personalized notification.

2. The system of claim 1, wherein the type of the sender-personalized notification comprises at least one of a ringtone, a color, a picture, a video, a multimedia message, a vibration, a text message, an audible cue, and a temperature.

3. The system of claim 1, wherein the recipient device is further configured to play a ringtone sent as the sender-personalized notification on the recipient device when the type of the sender-personalized notification is a ringtone.

4. The system of claim 1, wherein
the sender device is further configured to place a call to the recipient device to be placed at substantially a same time as the sender-personalized notification is sent to the recipient device; and
the recipient device is further configured to determine that the sender-personalized notification corresponds to the call and to process the sender-personalized notification with the call.

5. The system of claim 1, wherein the sender device is further configured to send the sender-personalized notification to a plurality of recipient devices.

6. The system of claim 1, wherein the sender-personalized notification comprises at least one of a notification and an identifier corresponding to the notification.

7. The system of claim 1, further comprising:
a notification server configured to receive the sender-personalized notification and the destination from the sender device and to send the sender-personalized notification to the recipient device.

8. The system of claim 7, wherein
the notification server comprises a digital repository populated with entries defining selectable notifications, and
the sender-personalized notification comprises at least one of an identifier corresponding to at least one entry of the digital repository and a notification.

9. The system of claim 7, wherein the sender-personalized notification is communicated between the notification server and at least one of the sender device and the recipient device as at least one of SMS, EMS, MMS, IMPS, and TCP/IP.

10. The system of claim 1, wherein at least one of the sender device and the recipient device comprises a wireless device.

11. The system of claim 1, wherein at least one of the sender device and the recipient device comprises a fixed line device.

12. The system of claim 11, wherein the fixed line device comprises at least one of a telephone and a television set-top box.

13. The system of claim 1, wherein the sender-personalized notification is stored in the recipient device in a digital repository of the recipient device in an entry corresponding to the sender device.

14. The system of claim 1, wherein the sender-personalized notification is stored in the recipient device in a digital repository of the recipient device in an entry corresponding to an entity associated with the sender device.

15. A method for pushing a sender-personalized notification with a call, comprising the steps of:
selecting the sender-personalized notification;
selecting a recipient phone number;
placing the call including sending the recipient phone number and sending the sender-personalized notification;
determining that the sender-personalized notification corresponds to the call; and
processing the sender-personalized notification based on a type of the sender-personalized message by a recipient device when the call is received.

16. The method of claim 15, wherein the type of the sender-personalized notification comprises at least one of a ringtone, a color, a picture, a video, a multimedia message, a vibration, a text message, an audible cue, and a temperature.

17. The method of claim 15, wherein the processing step comprises playing a sender-personalized ringtone on the recipient device when the type of the sender-personalized notification is a ringtone.

18. The method of claim 15, wherein the placing the call step comprises sending the sender-personalized notification as at least one of a short message service (SMS) message, an enhanced messaging service (EMS) message, a multimedia messaging service (MMS) message, an immediate messaging (IM) message, an immediate messaging and presence services (IMPS) message, a mobile e-mail message, a Internet protocol-based multimedia service (IMS) message, and a TCP/IP message.

19. A wireless device, comprising:
a processor; and
a computer readable medium encoded with processor readable instructions that when executed by the processor implement
a sender-personalized notification selection mechanism configured to select a notification as the sender-personalized notification to be sent to a recipient device with a call placed by the wireless device, and
a call placing mechanism configured to send the sender-personalized notification when the call is placed to the recipient device.

20. The wireless device of claim 19, wherein:
the call placing mechanism is further configured to send the sender-personalized notification as at least one of a short message service (SMS) message, an enhanced messaging service (EMS) message, a multimedia messaging service (MMS) message, an immediate messaging (IM) message, an immediate messaging and presence services (IMPS) message, a mobile e-mail message, a Internet protocol-based multimedia service (IMS) message, and a TCP/IP message.

21. A fixed line device, comprising:
a processor; and
a computer readable medium encoded with processor readable instructions that when executed by the processor implement
a sender-personalized notification selection mechanism configured to select a notification as the sender-personalized notification to be sent to a recipient device with a call placed by the fixed line device, and
a call placing mechanism configured to send the sender-personalized notification when the call is placed to the recipient device.

22. The fixed line device of claim 21, wherein:
the call placing mechanism is further configured to send the sender-personalized notification as at least one of a short message service (SMS) message, an enhanced messaging service (EMS) message, a multimedia messaging service (MMS) message, an immediate messaging (IM) message, an immediate messaging and presence services (IMPS) message, a mobile e-mail message, a Internet protocol-based multimedia service (IMS) message, and a TCP/IP message.

23. A wireless device, comprising:
a processor; and
a computer readable medium encoded with processor readable instructions that when executed by the processor implements a sender-personalized message processing mechanism configured to process a sender-personalized notification received with a call.

24. The wireless device of claim 23, wherein the sender-personalized notification processing mechanism is further configured to play a ringtone sent as the sender-personalized notification on the wireless device when a type of the sender-personalized message is a ringtone.

25. The wireless device of claim 23, wherein the sender-personalized message processing mechanism is further configured to process the sender-personalized notification based on a type of the sender-personalized notification, and
the type of the sender-personalized notification is at least one of a ringtone, a color, a picture, a video, a multimedia message, a vibration, a text message, an audible cue, and a temperature.

26. A fixed line device, comprising:
a processor; and
a computer readable medium encoded with processor readable instructions that when executed by the processor implements a sender-personalized message processing mechanism configured to process a sender-personalized notification received with a call.

27. The fixed line device of claim 26, wherein the sender-personalized notification processing mechanism is further configured to play a ringtone sent as the sender-personalized notification on the fixed line device when a type of the sender-personalized message is a ringtone.

28. The fixed line device of claim 26, wherein
the sender-personalized message processing mechanism is further configured to process the sender-personalized notification based on a type of the sender-personalized notification, and
the type of the sender-personalized notification is at least one of a ringtone, a color, a picture, a video, a multimedia message, a vibration, a text message, an audible cue, and a temperature.

29. A computer program product, comprising:
a computer storage medium; and
a computer program code mechanism embedded in the computer storage medium for causing a processor to select and send a sender-personalized notification to a recipient device when placing a call, the computer program code mechanism having
a first computer code device configured to select a notification as the sender-personalized notification to be sent to a recipient device with the call placed by a sender device, and
a second computer code device configured to send the sender-personalized notification when the call is placed to the recipient device.

30. The computer program product of claim 29, wherein the second computer code device is further configured to send the sender-personalized notification as at least one of a short message service (SMS) message, an enhanced messaging service (EMS) message, a multimedia messaging service (MMS) message, an immediate messaging (IM) message, an immediate messaging and presence services (IMPS) message, a mobile e-mail message, a Internet protocol-based multimedia service (IMS) message, and a TCP/IP message.

31. A computer program product, comprising:
a computer storage medium; and
a computer program code mechanism embedded in the computer storage medium for causing a processor to process a sender-personalized notification received with a call, the computer program code mechanism having
a first computer code device configured to process the sender-personalized notification received with the call.

32. The computer program product of claim 31, wherein the first computer code device is further configured to play a ringtone sent as the sender-personalized notification when a type of the sender-personalized notification is a ringtone.

33. The computer program product of claim 31, wherein
the first computer code device is further configured to process the sender-personalized notification based on a type of the sender-personalized notification, and
the type of the sender-personalized notification is at least one of a ringtone, a color, a picture, a video, a multimedia message, a vibration, a text message, an audible cue, and a temperature.

34. A system for pushing a sender-personalized notification with a call, comprising:
means for selecting the sender-personalized notification;
means for selecting a recipient phone number;
means for placing the call including sending the recipient phone number and sending the sender-personalized notification;
means for determining that the sender-personalized notification corresponds to the call; and
means for processing the sender-personalized notification based on a type of the sender-personalized message by a recipient device when the call is received.

35. The system of claim 1, wherein the recipient device is further configured to process a software upgrade sent as the sender-personalized notification on the recipient device when the type of the sender-personalized message is a software upgrade.

36. The method of claim 15, wherein the processing step comprises processing a software upgrade on the recipient device when the type of the sender-personalized notification is a software upgrade.

37. The wireless device of claim 23, wherein the sender-personalized notification processing mechanism is further configured to process a software upgrade sent as the sender-personalized notification on the wireless device when a type of the sender-personalized notification is a software upgrade.

38. The computer program product of claim 31, wherein the first computer code device is further configured to process a software upgrade sent as the sender-personalized notification when a type of the sender-personalized notification is a software upgrade.

39. A mobile switching center, comprising:
a processor; and
a computer readable medium encoded with processor readable instructions that when executed by the processor implement
a sender-personalized notification enabling mechanism configured to determine if a sender of a call sent a sender-personalized notification at substantially a same time as placing the call, and
a sender-personalized notification pushing mechanism configured to send the sender-personalized notification at substantially a same time as the call is routed to a recipient of the call.

40. The mobile switching center of claim 39, wherein the sender-personalized message comprises at least one of a short message service (SMS) message, an enhanced messaging service (EMS) message, a multimedia messaging service (MMS) message, an immediate messaging (IM) message, an immediate messaging and presence services (IMPS) message, a mobile e-mail message, a Internet protocol-based multimedia service (IMS) message, and a TCP/IP message.

41. The system of claim 1, wherein:
the recipient device comprises a phonebook; and
the recipient device is further configured to determine if the phonebook includes an entry for the sender device, and to store the sender-personalized notification as a custom notification corresponding to an entry associated with the sender device such that the notification received as the sender-personalized notification will be played by the recipient device when the recipient device receives a call from the sender device.

42. The method of claim 15, further comprising the steps of:
determining if a phonebook of the recipient device includes an entry for a sender of the call;
storing the sender-personalized notification as a custom notification corresponding to an entry associated with the sender of the call; and
playing by the recipient device the custom notification when the recipient device receives a call from the sender of the call.

43. The wireless device of claim 23, wherein the sender-personalized notification processing mechanism is further configured to determine if a phonebook of the wireless device includes an entry for a sender of the call, and to store the sender-personalized notification as a custom notification corresponding to an entry associated with the sender of the call such that the custom notification will be played by the wireless device when the wireless device receives a call from the sender of the call.

44. The fixed line device of claim 26, wherein the sender-personalized notification processing mechanism is further configured to determine if a phonebook of the fixed line device includes an entry for a sender of the call, and to store the sender-personalized notification as a custom notification corresponding to an entry associated with the sender of the call such that the custom notification will be played by the fixed line device when the fixed line device receives a call from the sender of the call.

45. The fixed line device of claim 26, wherein the sender-personalized notification processing mechanism is further configured to process a software upgrade sent as the sender-personalized notification on the fixed line device when a type of the sender-personalized notification is a software upgrade.
